(19) United States
(12) Patent Application Publication
(10) Pub. No.: US 2008/0196560 A1
(43) Pub. Date: Aug. 21, 2008

(54) CONNECTING ASSEMBLY

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 12/110,360

(22) Filed: Apr. 28, 2008

Related U.S. Application Data
(63) Continuation-in-part of application No. 11/546,273, filed on Oct. 12, 2006.

(51) Int. Cl. B25B 23/00

(52) U.S. Cl. 81/177.85

(57) ABSTRACT

A connecting assembly includes a connecting rod having an axial penetrating hole which is a stepped hole and thus is formed with a stepped edge; an upper end of the connecting rod is formed with an enlarged end as a connecting portion; a through hole penetrated through the enlarged end of the connecting rod; a push rod received in the penetrating hole; a lower end of the push rod being connected to a combining portion; an upper end of the push rod being formed as a resisting end; and a press rod passing through the through hole of the combining portion; two ends of the press rod protruding from the two openings of the through hole; a lower middle section of the press rod being formed with a cambered recess corresponding to the resisting end.

The present invention is a continuation in part (CIP) of U.S. patent application Ser. No. 11/546,273 which is assigned to and having an invention invented by the inventor of the present invention. The contents of the U.S. patent application Ser. No. 11/546,273. are incorporated into the present invention as a part of the present invention.

### FIELD OF THE INVENTION

The present invention relates to connecting assemblies, and particularly to a connecting assembly, wherein a sleeve connected thereto can be removed with little force. Moreover, the structure is simple and cost is low.

### BACKGROUND OF THE INVENTION

Referring to FIGS. 6 and 7, a prior art structure for engaging a sleeve is illustrated. A connecting rod has a stepped trapezoidal recess. When a press rod is pressed, the press rod will drive a resisting end of a push rod to move away from a sloped surface in the recess. Then the push rod moves so that a buckling ball falls into a hole of the push rod. Thus a sleeve can be removed. However the trapezoidal recess is formed by a flat surface and two inclined surfaces and thus the resisting end of the push rod is easy to be confined in the connection area of the flat surface and the inclined surfaces. Thus a great force is necessary to remove the sleeve from the combining portion of the connecting assembly.

### SUMMARY OF THE INVENTION

Accordingly, the primary object of the present invention is to provide a connecting assembly, wherein a sleeve connected thereto can be removed with little force. Moreover, the structure is simple and cost is low.

To achieve above objects, the present invention provides a connecting assembly comprising: a connecting rod having an axial penetrating hole which is a stepped hole and thus is formed with a stepped edge; an upper end of the connecting rod is formed as an enlarged end as a connecting portion; a through hole penetrated through the enlarged end of the connecting rod; a push rod received in the penetrating hole; a lower end of the push rod being connected to a combining portion; an upper end of the push rod being formed as a resisting end; and a press rod passing through the through hole of the combining portion; two ends of the press rod protruding from the two openings of the through hole; a lower middle section of the press rod being formed with a cambered recess corresponding to the resisting end; and wherein when the press rod is pressed, the resisting end of push rod will slide out of the cambered recess of the press rod so as to drive the push rod.

The various objects and advantages of the present invention will be more readily understood from the following detailed description when read in conjunction with the appended drawing.

### BRIEF DESCRIPTION OF THE DRAWINGS

FIG. 1 is a schematic view about the structure of the present invention.

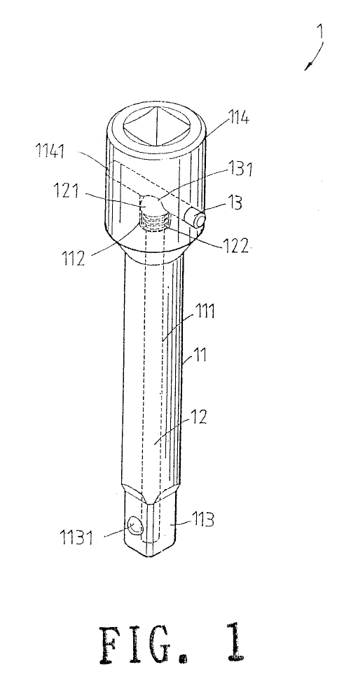

FIGS. 2 and 3 are cross sectional views about the operation of the present invention.

FIG. 4 is a schematic view showing that the present invention is combined with a spanner.

FIG. 5 is a cross sectional view showing that the elastic unit of the present invention has a sleeve form.

FIGS. 6 and 7 are schematic cross sectional view of the prior art connecting structure.

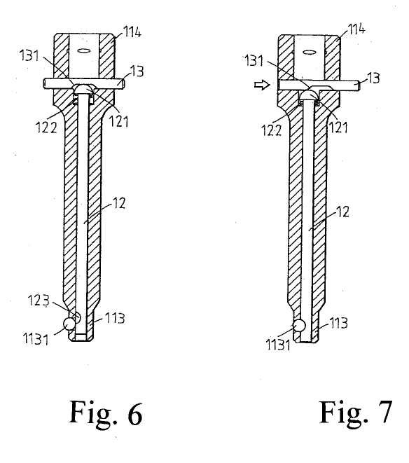

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

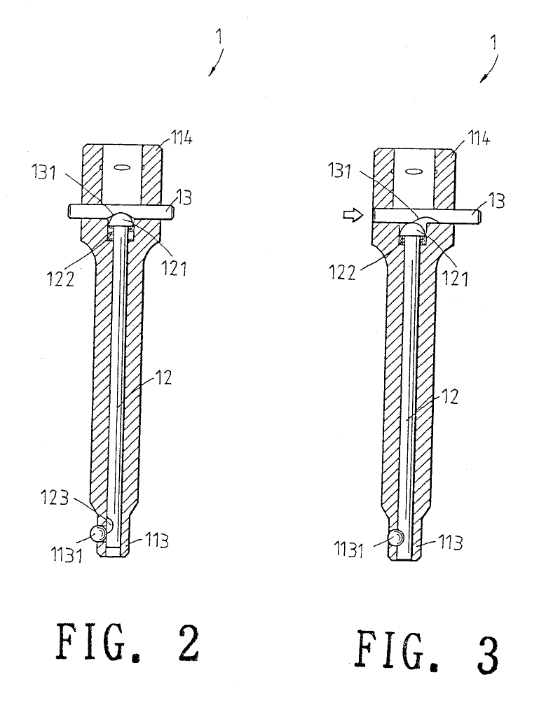

With referring to FIG. 2, the structure of the present invention is illustrated. The present invention has the following elements.

A connecting rod 11 has an axial penetrating hole 111 which is a stepped hole and thus is formed with a stepped edge 112. An upper end of the connecting rod 11 is formed as an enlarged end as a connecting portion 114. A through hole 1141 penetrates through the enlarged end of the connecting rod 11.

A push rod 12 is received in the penetrating hole 111. A lower end of the push rod 12 is connected to a combining portion 113. A buckling ball 1131 is installed in the combining portion 113. One side of the buckling ball 1131 protrudes out from the combining portion 113 and another side of the buckling ball 1131 resists against the push rod 12. An elastic unit 122 sleeves an upper end of the push rod 12. The elastic unit 122 resists against the stepped edge 112 of the connecting rod 11. An upper end of the push rod 12 is formed as a resisting end 121. A lower end of the push rod 12 is formed with a receiving slot 123 for receiving the buckling ball 1131. The receiving slot 123 has a size exactly matching a part of an outline of the buckling ball 1131 so that as the buckling ball 1131 is located in the slot 123, the part of the buckling ball 131 is adhered on an inner wall of the buckling ball without sliding axially along the push rod 12.

A press rod 13 passes through the through hole 1141 of the combining portion 113. Two ends of the press rod 13 protrude from the two openings of the through hole 1141. A lower middle section of the press rod 13 is formed with a cambered recess 131 corresponding to the resisting end 121.

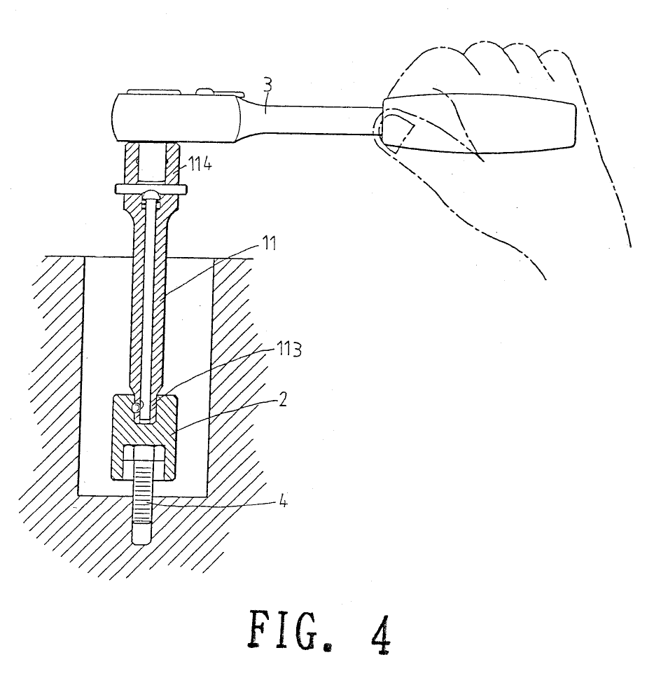

Referring to FIG. 2, in assembly, the push rod 12 passes through the through hole 1141 of the connecting portion 114 and the recess 131 of the press rod 13 is aligned to the resisting end 121. The buckling ball 1131 resists against the receiving slot 123 of the push rod 12. By the buckling ball 1131, the combining portion 113 can be used to buckle an object (referring to FIG. 4).

Referring to FIG. 3, when the press rod 1 3 is pressed, the resisting end 121 will slide out of the cambered recess 131 along the cambered path of the cambered recess 131 and drive the push rod 12 to compress the elastic unit 122. Then the receiving slot 123 moves with the push rod 12 so as to receive the buckling ball 1131 so that the buckling ball 1131 enters into the object 2 enclosing the combining portion 113.

When the object 2 sleeves the combining portion 113, the push rod 12 is pushed back to the center of the connecting portion 114. By the resilient force of the elastic unit 122, the push rod 12 is pushed to the cambered recess 131 of the press rod 13. Then the receiving slot 123 of the push rod 12 will push the buckling ball 1131 so that the buckling ball 1131 moves away from the receiving slot 123 and resists between the object 2 and the push rod 12. Thus, the object 2 is steadily installed upon the combining portion 113 for operation.

With referring to FIG. 4, in use of the present invention, the connecting portion 114 of the body 1 is installed to a spanner 3, and then the combining portion 113 is sleeved by the object 2. The object 2 will be further engaged to a screw unit 4 so that when the spanner 3 is driven, the connecting rod 11 and the object 2 will be driven so as to tighten or release the screw unit 4.

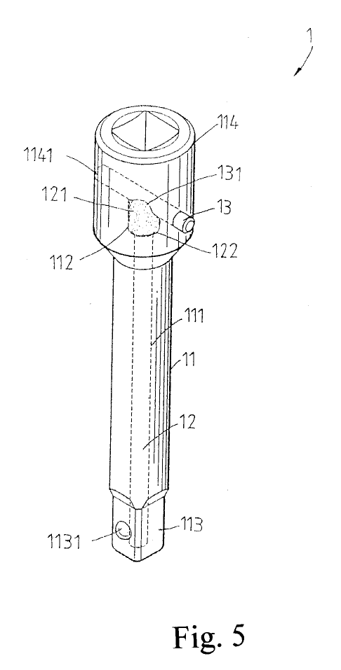

Referring to FIG. 5, it is illustrated that in the present invention, the elastic unit 122 has a sleeve form which may be a rubber sleeve or an elastic polymer sleeve.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A connecting assembly comprising:
a connecting rod having an axial penetrating hole which is a stepped hole and thus is formed with a stepped edge; an upper end of the connecting rod is formed with an enlarged end which is as a connecting portion; a through hole penetrated through the enlarged end of the connecting rod;
a push rod received in the penetrating hole; a lower end of the push rod being connected to a combining portion; an upper end of the push rod being formed as a resisting end; and
a press rod passing through the through hole of the combining portion; two ends of the press rod protruding out from two openings of the through hole; a lower middle section of the press rod being formed with a cambered recess corresponding to the resisting end; and
wherein when the press rod is pressed, the resisting end of push rod will slide out of the cambered recess of the press rod so as to drive the push rod;
wherein an elastic unit sleeves an upper end of the push rod; the elastic unit resists against the stepped edge of the connecting rod;
wherein a buckling ball is installed in the combining portion; one side of the buckling ball protrudes out from the combining portion and another side of the buckling ball resists against the push rod; and
wherein a lower end of the push rod is formed with a receiving slot for receiving the buckling ball; wherein the receiving slot has a size exactly matching a part of an outline of the buckling ball so that as the buckling ball is located in the slot, the part of the buckling ball is adhered on an inner wall of the slot without sliding linearly along the push rod.

2. The connecting assembly as claimed in claim 1, wherein the elastic unit is a spring.

3. The connecting assembly as claimed in claim 1, wherein the elastic unit is an elastic sleeve.

4. The connecting assembly as claimed in claim 1, wherein the elastic unit is a rubber sleeve.

5. The connecting assembly as claimed in claim 1, wherein the elastic unit is an elastic polymer sleeve.
